(19) United States
(12) Patent Application Publication
(10) Pub. No.: US 2008/0080096 A1
(43) Pub. Date: Apr. 3, 2008

(54) Head slider supporting device and storage device

(75) Inventor: Hajime Miura, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/788,144

(22) Filed: Apr. 18, 2007

(30) Foreign Application Priority Data
Sep. 28, 2006 (JP) 2006-264817

(51) Int. Cl. G11B 5/48

(52) U.S. Cl. 360/245.8

(57) ABSTRACT

There is provided a head slider supporting device and a storage device capable of reducing the influence of a crosstalk between wirings.

A head slider supporting device has one terminal connected to a magnetic head slider and the other terminal connected to a preamplifier IC. The head slider supporting device includes a supporting portion (flexure) that includes a conductor for supporting the magnetic head slider; an insulation portion that includes a dielectric contacting the supporting portion; a heater signal line 31a that is a wiring for connecting the magnetic head slider and preamplifier IC in order to control a heater provided in the magnetic head slider and that contacts the insulation portion; a heater GND line 30a that is a wiring for connecting the magnetic head slider and preamplifier IC in order to connect a heater and a ground and that contacts the insulation portion; and a GND connection line 30b that is a wiring for connecting the heater GND line 30a and supporting portion.

### BACKGROUND OF THE INVENTION

1. Field of the Invention

The present invention relates to a head slider supporting device and a storage device having a transmission path connecting a head slider and a preamplifier IC.

2. Description of the Related Art

Along with an increase in the recording density and transfer rate of a hard disk drive (HDD), it has been becoming difficult to record/reproduce a signal. To increase the performance of the HDD, a technique that controls the levitation amount of a magnetic head slider has been proposed. This is a technique (levitation control system) in which a heater resistor is incorporated in the magnetic head slider and is heated to control the levitation amount of the magnetic head slider, thereby improving writing performance of a write signal onto a disk recording medium and reading performance of a read signal therefrom.

As a prior art relating to the present invention, there is known a magnetic head slider with a built-in heater resistor that prevents occurrence of a crosstalk current to a reproduction element (refer to, e.g., Jpn. Pat. Appln. Laid-Open Publication No. 2006-79755 (U.S. Patent No. 2006/0056110)) (Patent Document 1).

FIG. 12 is a circuit view showing an example of electrical connection between a magnetic head slider adopting a conventional levitation control system and a preamplifier IC. The magnetic head slider is constituted by a slider base plate 3a and a thin-film head section 3b and is bonded to a suspension 2 which is a conductor by adhesive. An MR (Magnetoresistive) element 61 in the thin-film head section 3b is connected to a read input of a preamplifier IC 5 via a read signal lines 40a and 41a formed on the suspension 2. The MR element (magnetoresistive effect element) 61 may be an MR element, such as GMR or TuMR type, that can realize high density reproduction.

Unlike the technique disclosed in Patent Document 1, the MR element 61 is connected to the conductive slider base plate 3a via a shunt resistor 64 with a high resistance (several tens of K ohms) by a conductor penetrating the thin-film head section 3b in order to minimize ESD (electrostatic discharge) damage. A write coil 62 in the thin-film head section 3b is connected to a write current output of the preamplifier IC 5 via write signal lines 50a and 51a formed on the suspension 2. A heater resistor 63 in the thin-film head section 3b is connected to a heater signal output of the preamplifier IC 5 via a heater signal line 31a formed on the suspension 2 and to a heater ground of the preamplifier IC 5 via a heater GND line 30a formed on the suspension 2. Further, unlike the technique of Patent Document 1, in order to minimize ESD damage, the ground connection terminal of the heater resistor 63 is connected to the slider base plate 3a by a conductor penetrating the thin-film head section 3b, as in the case of the MR element 61.

In the configuration described above, noise (disturbance noise) generated by motor rotation or electric wave from outside propagates through a disk recording medium. This noise easily propagates to the magnetic head slider since the interval between the disk recording medium and magnetic head slider at the HDD operating time is very small at a nano-order. Further, at the HDD reading time, this disturbance noise propagates from the slider base plate 3a, via the heater GND line 30a and preamplifier IC 5, to the ground of the preamplifier IC in the order mentioned.

Further, the line length from the magnetic head slider to the preamplifier IC is so long (several tens of mm), that the disturbance noise is superimposed on the read signal by a crosstalk from the heater GND line 30a to the read signals 40a and 41a, thereby increasing the error rate of the HDD.

As a countermeasure to the disturbance noise, there available a method of adding conductive adhesive for electrically connecting the slider base plate 3a and suspension 2, in addition to the adhesive for fixing the magnetic head slider to the suspension 2. However, the resistance value of the conductive adhesive is high (several hundreds of Ω) and connectivity thereof is low, so that a sufficient ground connection effect cannot be obtained. Further, the addition of the conductive adhesive may deform the suspension, thereby adversely affecting the mechanical characteristics of the suspension.

As another prior art relating to the present invention, there is known a magnetic head slider including a dedicated pad for connecting the suspension 2 and slider base plate 3a (refer to, e.g., Jpn. Pat. Appln. Laid-Open Publication No. 8-111015 (Patent Document 2), Jpn. Pat. Appln. Laid-Open Publication No. 2005-116127 (U.S. Patent No. 2005/0078416) (Patent Document 3), U.S. Patent No. 2003/0128474 (Patent Document 4), U.S. Patent No. 2004/0070880 (Patent Document 5), U.S. Patent No. 2005/0195528 (Patent Document 6), and U.S. Pat. No. 7,006,330 (Patent Document 7)).

However, in recent years, an HDD adopts a load/unload mechanism for improvement of impact resistance and, therefore, the inertia of an actuator becomes increased as compared to the case where the load/unload mechanism is not adopted. Further, in order to achieve a further reduction of the levitation height of the magnetic head slider, the magnetic head slider is becoming further reduced in size and weight. In addition, the number of signal lines connected to the levitation control magnetic head slider has been increased from four (two read wirings and two write wirings) in a conventional magnetic head slider that does not adopt the levitation control system to six (two heater wirings are added). Therefore, when both the miniaturization and levitation control system are simultaneously adopted in the magnetic head slider, the width of each pad for connecting signal lines of the magnetic head slider and interval between the pads become reduced as compared to the conventional magnetic head slider, as well as, the number of signal lines connecting the magnetic head slider and preamplifier IC is increased. Therefore, it is difficult to adopt the techniques disclosed in Patent Documents 2 to 7.

As described above, there does not exist an effective means against the disturbance noise generated in the case where the levitation control magnetic head slider is used.

### SUMMARY OF THE INVENTION

The present invention has been made to solve the above problems and an object thereof is to provide a head slider supporting device and a storage device capable of reducing the influence of a crosstalk between wirings.

To solve the above problems, according to a first aspect of the present invention, there is provided a head slider supporting device for supporting a head slider provided with at least a heater element, comprising: a supporting portion that includes a conductor for supporting the head slider; an insulation portion that includes a dielectric contacting the supporting portion; a heater signal line that is a wiring for supplying a power to the heater element and that contacts the insulation portion; a GND line for heater that is a wiring for connecting the heater element and a ground potential and that contacts the insulation portion; and a GND connection portion that is a connection portion for connecting the GND line for heater and the supporting portion.

In the head slider supporting device according to the present invention, a GND connection terminal of the heater element is connected to a slider base plate of the head slider.

In the head slider supporting device according to the present invention, both terminals of a magnetoresistive effect element provided on the head slider is connected to the slider base plate of the head slider via a high-resistance resistor provided on the head slider.

In the head slider supporting device according to the present invention, the insulation portion has a hole for the GND connection portion to pass through.

In the head slider supporting device according to the present invention, the GND connection portion is arranged in the position where it does not contact a jig and other components.

The head slider supporting device according to the present invention further comprises one or more write signal lines that are wirings for supplying a power to a write element provided in the head slider; one or more read signal lines that are wirings for supplying a power to a read element provided in the head slider; a retaining portion that retains the heater signal line, write signal line, and read signal line, wherein at least one of distances between the heater signal line and write signal line and between the heater signal line and read signal line is larger than a distance between the heater signal lines in a predetermined region in the retaining portion.

In the head slider supporting device according to the present invention, the predetermined region is a Tail portion in a Long Tail suspension.

In the head slider supporting device according to the present invention, the distance is a distance in the width direction of the head slider supporting device.

In the head slider supporting device according to the present invention, the write signal line, heater signal line, and read signal line are arranged in this order in the width direction of the head slider supporting device.

According to a second aspect of the present invention, there is provided a head slider supporting device for supporting a head slider provided with at least a heater element, comprising: one or more heater signal lines that are wirings for supplying a power to the heater element; one or more write signal lines that are wirings for supplying a power to a write element provided in the head slider; one or more read signal lines that are wirings for supplying a power to a read element provided in the head slider; a retaining portion that retains the heater signal line, write signal line, and read signal line, wherein at least one of distances between the heater signal line and write signal line and between the heater signal line and read signal line is larger than a distance between the heater signal lines in a predetermined region in the retaining portion.

According to a third aspect of the present invention, there is provided a storage device comprising: a head controller that controls a head section; a supporting portion that includes a conductor for supporting a head slider in which the head section is provided; an insulation portion that includes a dielectric contacting the supporting portion; a heater signal line that is a wiring for connecting the head slider and head controller in order to control a heater provided in the head slider and that contacts the insulation portion; a GND line for heater that is a wiring for connecting the heater and a ground and that contacts the insulation portion; and a GND connection portion that is a connection portion for connecting the GND line for heater and supporting portion.

According to the present invention, it is possible to reduce the influence of a crosstalk between wirings in a storage device mounting a head slider with a heater at the reading/writing operation time. Therefore, reliability of data storage can be increased and higher density recording can be achieved.

### BRIEF DESCRIPTION OF THE DRAWINGS

FIG. 1 is a view showing an example of a structure of an actuator according to an embodiment of the present invention;

FIG. 2 is a view showing an example of a structure of the magnetic head slider according to the embodiment;

FIG. 3 is a circuit view showing an example of electrical connection between a levitation control magnetic head slider according to the embodiment and a preamplifier IC;

FIG. 4 is a view showing an example of a structure of a suspension according to the embodiment;

FIG. 5 is a view showing an example of a structure of a flexure according to the embodiment;

FIG. 6 is a cross-sectional view showing an example of a structure of the wiring in a conventional Tail portion;

FIG. 7 is a cross-sectional view showing an example of a structure of the wiring in the Tail portion according to the embodiment;

FIG. 8 is a view showing an example of a structure in the vicinity of a GND connection line according to the embodiment;

FIG. 9 is a cross-sectional view showing an example of a structure in the vicinity of the GND connection line according to the embodiment;

FIG. 10 is a view showing an example of a structure when the suspension according to the embodiment is caulked to the actuator block;

FIG. 11 is a view showing an example of a structure of a part in the vicinity of the magnetic head slider when the suspension according to the embodiment is caulked to the actuator block; and

FIG. 12 is a circuit view showing an example of electrical connection between a magnetic head slider adopting a conventional levitation system and a preamplifier IC.

### DETAILED DESCRIPTION OF THE PREFERRED EMBODIMENTS

An embodiment of the present invention will be described below with reference to the accompanying drawings.

A configuration of an actuator in a magnetic disk unit (storage device) according to the present embodiment will be descried.

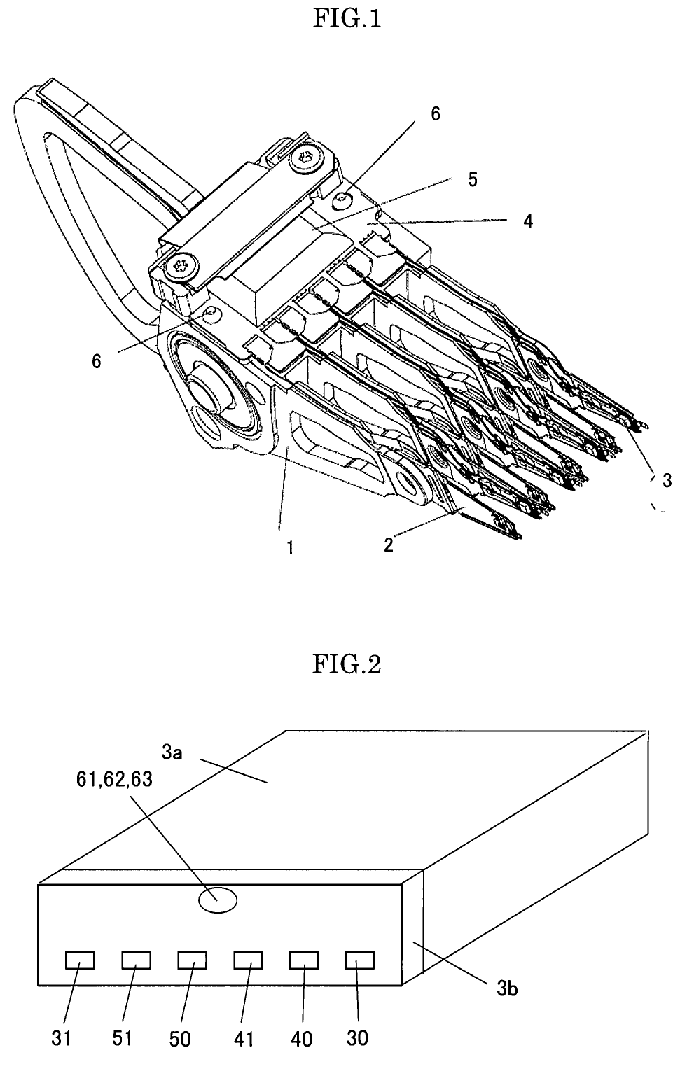

FIG. 1 is a view showing an example of a structure of the actuator according to the present embodiment. A suspension 2 and an FPC (Flexible Printed Circuit) 4 are mounted in an actuator block 1. The magnetic head slider 3 is a levitation control magnetic head slider and is bonded to the distal end of the suspension 2 by adhesive. A preamplifier IC 5 is mounted in the FPC 4. The preamplifier IC generally includes not only a signal amplifier circuit but also a head selection circuit for head selection, a control circuit of current to a heater, or the like, and functions as a head controller (head IC) that controls a head based on a control signal from a controller such as a MPU (Micro Processing Unit) or HDC (Hard Disk Controller).

A signal line of the preamplifier IC 5 formed on the FPC 4 and signal line formed on the suspension 2 are connected to each other by soldering or the like. The preamplifier IC 5 and magnetic head slider 3 are connected via the connected signal line. The actuator block 1 which is a conductor and the ground of the preamplifier IC 5 formed on the FPC 4 are connected to each other at a pin 6 projecting from the actuator block 1 by soldering or the like. The suspension 2 which is a conductor is fixed to an actuator block 1 by caulking. The ground of the preamplifier IC 5 and suspension 2 are connected to each other through the actuator block 1. The material of the actuator block 1 is, in general, aluminum. Disk recording media are inserted between the respective head sliders 3 and rotated. With a change of the angle of the actuator, the position of the magnetic head slider 3 is shifted to a target track on the disk recording medium.

A configuration of the magnetic head slider 3 according to the embodiment will next be described.

FIG. 2 is a view schematically showing an example of a structure of the magnetic head slider 3 according to the embodiment. The magnetic head slider 3 is constituted by a slider base plate 3a and a thin-film head section 3b. An MR element 61, a write coil 62, a heater resistor 63, a shunt resistor 64, read signal line connection pads 40 and 41, write signal line connection pads 50 and 51, a heater signal line connection pad 31, a heater GND line connection pad 30 are stacked on the thin-film head section 3b of the slider base plate 3a. Similarly, a conductor connecting the above components and a conductor connecting the slider base plate 3a, heater resistor 63, and shunt resistor 64 are stacked on the thin-film head section 3b. The MR element 61, write coil 62, and heater resistor 63 are integrated and disposed on the levitation surface side (side opposed to the disk recording medium) of the magnetic head slider. In the thin-film head section 3b, the MR element 61 is connected to the read signal line connection pads 40 and 41, the write coil 62 is connected to the write signal line connection pads 50 and 51, and the heater resistor 63 is connected to the heater GND line connection pad 30 and heater signal line connection pad 31. The material of the slider base plate 3a is, in general, alumina-titanium carbide which is a conductive material.

Electrical connection between the magnetic head slider 3 and preamplifier IC 5 in the suspension 2 in the embodiment will next be described.

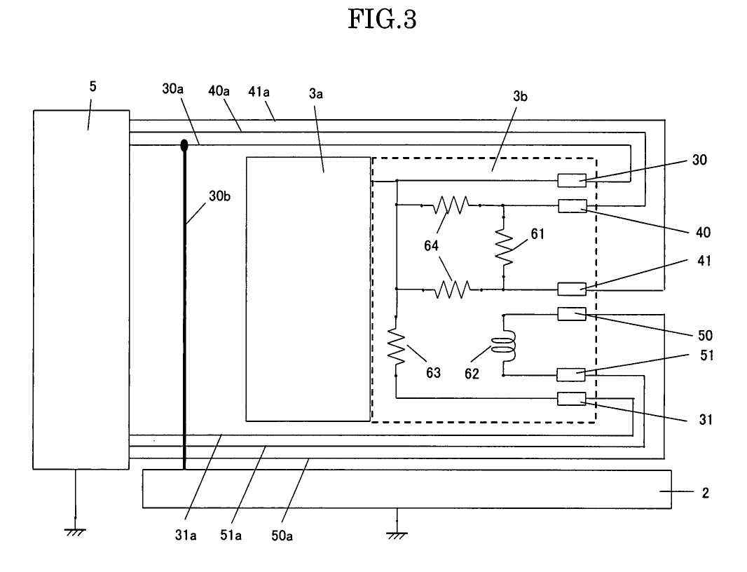

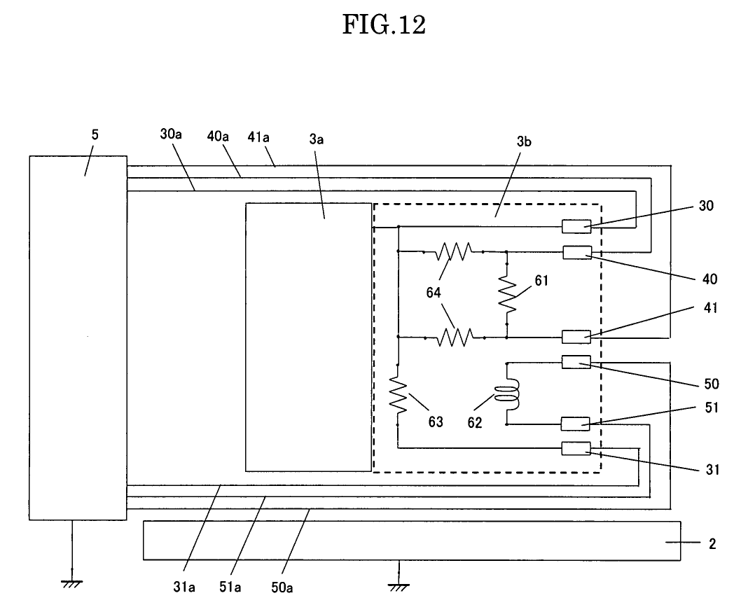

FIG. 3 is a circuit view showing an example of electrical connection between the levitation control magnetic head slider according to the present invention and preamplifier IC. In FIG. 3, the same reference numerals as those in FIG. 12 denote the same or corresponding parts as those in FIG. 12, and the descriptions thereof will be omitted here. A difference from FIG. 12 is that a GND connection line 30b connecting the heater GND line 30a and a flexure which is a component of the suspension 2 is newly provided.

A structure of the suspension 2 according to the present embodiment will next be described.

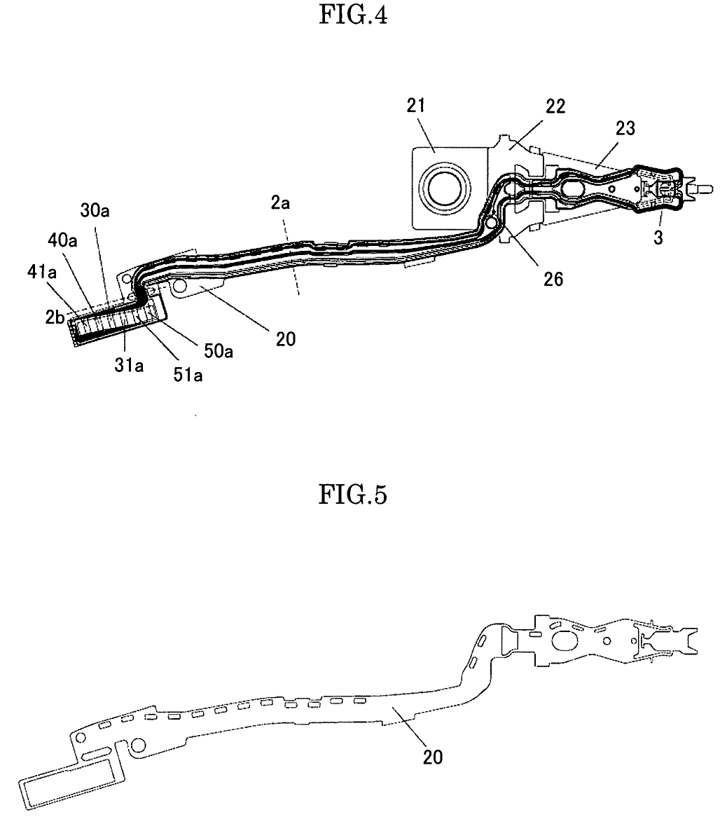

FIG. 4 is a view showing an example of a structure of the suspension according to the present embodiment. This illustration shows the entire structure of the suspension 2. In FIG. 4, the magnetic head slider 3 is bonded to the suspension 2 by adhesive. FIG. 5 shows the shape of a flexure 20 which is a component of the suspension 2. A base plate 21, a hinge plate 22, and a load beam 23 are connected to the flexure 20 by laser spot welding. On the flexure 20, a dielectric 24, read signal lines 40a and 41a, write signal lines 50a and 51a, a heater signal line 31a, a heater GND line 30a, and a coverlay 25 are formed. The material of the flexure 20, base plate 21, hinge plate 22, and load beam 23 is stainless steel. The material of the signal line is copper, that of the dielectric 24 is polyimide, and that of the coverlay 25 is polyimide or epoxy. When the suspension 2 is fitted to the actuator block 1, the base plate 21 is fixed to the actuator block 1 by caulking. When the signal line of the preamplifier IC 5 formed on the FPC 4 and signal line formed on the flexure 20 are connected to each other by soldering or the like, the flexure 20 is folded by 90°, along the dotted line 2b.

The suspension 2 according to the present embodiment is a Long Tail suspension which has a long Tail portion (portion from the hinge plate 22 to the flexure 20 in FIG. 4). A nickel plating 26 serving as the GND connection line 30b is arranged in the vicinity of the hinge plate 22.

The wiring in the Tail portion in the present embodiment will next be described.

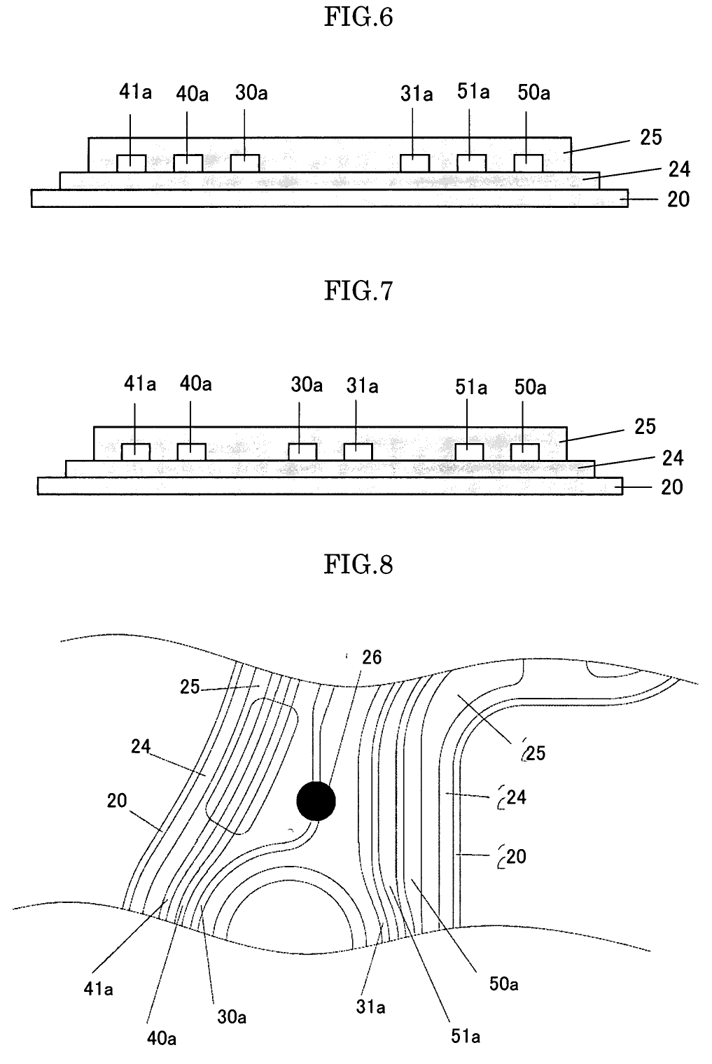

The wiring in a conventional Tail portion and that in a Tail portion according to the present embodiment are compared. FIG. 6 is a cross-sectional view showing an example of a structure of the wiring in a conventional Tail portion. In FIG. 6, the same reference numerals as those in FIG. 4 denote the same or corresponding parts as those in FIG. 4, and the descriptions thereof will be omitted here. The dielectric 24 is formed on the flexure 20, patterns of the heater GND line 30a, heater signal line 31a, read signal lines 40a and 41a, write signal lines 50a and 51a are formed on the dielectric 24, and coverlay 25 is formed on those patterns. This illustration shows a cross-section of the conventional Tail portion. In the conventional arrangement, heater signal line 31a and write signal 51a are close to each other, so that, at writing time, the crosstalk of the write signal line 51a propagates through the heater signal line 31a, which may result in a damage to the MR element 61.

FIG. 7 is a cross-sectional view showing an example of a structure of the wiring in the Tail portion according to the present embodiment. In FIG. 7, the same reference numerals as those in FIG. 6 denote the same or corresponding parts as those in FIG. 6, and the descriptions thereof will be omitted here. This illustration shows a cross-section 2a which is a cross-section of the Tail portion shown in FIG. 4. As shown in FIG. 7, the interval between the heater signal line 31a and write signal line 51a and interval between the heater GND line 30a and read signal line 40a are set longer than the interval between the heater GND line 30a and heater signal line 31a. Connecting the heater GND line 30a and flexure 20 by the GND connection line 30b (nickel plating 26) allows the actuator block 1 to function as the heater GND line 30a, eliminating the need to provide the heater GND line 30a extending from the GND connection line 30b (nickel plating 26) to preamplifier IC 5. Further, in the case where the heater GND line 30a extending from the GND connection line 30b (nickel plating 26) to preamplifier IC 5 is not provided as described above, a heater ground may be removed from the preamplifier IC 5.

As described above, when the interval between the heater wiring and read wirings (read signal lines 40a and 41a) and interval between the heater wiring and write wirings (write signal lines 50a and 51a) are set longer than the distance between the heater wirings (heater GND line 30a and heater signal line 31a), the crosstalk from the write signal to read signal can be reduced at the writing time.

The GND connection line 30b will next be described.

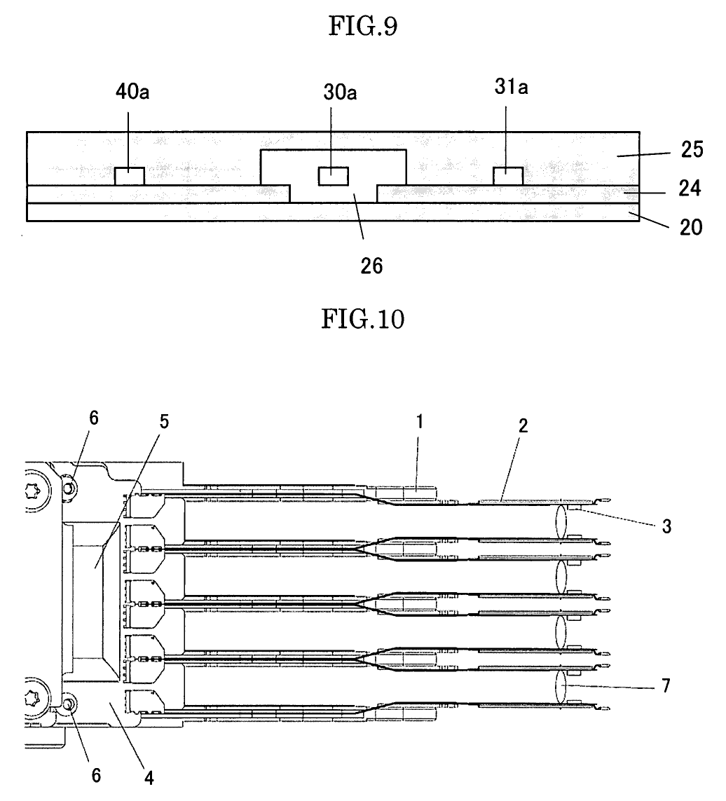

FIG. 8 is a view showing an example of a structure in the vicinity of the GND connection line 30b according to the present embodiment. This illustration shows the part of the GND connection line 30b (nickel plating 26) of FIG. 4 in an enlarged manner. FIG. 9 is a cross-sectional view showing an example of a structure in the vicinity of the GND connection line 30b according to the present embodiment. This illustration shows a cross-section of a part in the vicinity of the GND connection line 30b (nickel plating 26) of FIG. 8. A hole having a diameter of less than 200 μm is formed in the dielectric 24 at the position of the GND connection line 30b in FIG. 8, and the nickel plating 26 connects the heater GND line 30a and flexure 20 (conductor in the suspension 2) via the hole. The connection between the heater GND line 30a and flexure 20 in this case is a low resistance connection (less than 1Ω), thereby achieving good electrical connectivity between the heater GND line 30a and flexure 20.

Although the heater GND line 30a is arranged on the read wirings (read signal lines 40a and 41a) side and the heater signal line 31a is arranged on the write wirings (write signal lines 50a and 51a) side in the present embodiment, the heater GND line 30a may be arranged on the write wrings side. A plurality of GND connection lines 30b may be provided, and the heater GND lines 30a and flexure 20 are connected at a plurality of locations. Further, in addition to the use of the GND connection line 30b, conductive adhesive may be used to connect the slider base plate 3a and suspension 2.

By providing the GND connection line 30b, the slider base plate and suspension of the levitation control magnetic head slider are connected with a low resistance of less than 1Ω to allow the disturbance noise to flow the ground, thereby reducing the disturbance noise at the reading time.

The position of the GND connection line 30b will next be described.

The closer the position of the GND connection line 30b (nickel plating 26) to the magnetic head slider 3, the higher the noise reduction effect becomes. The position of the GND connection line 30b (nickel plating 26) in the present embodiment is determined by the following constraint.

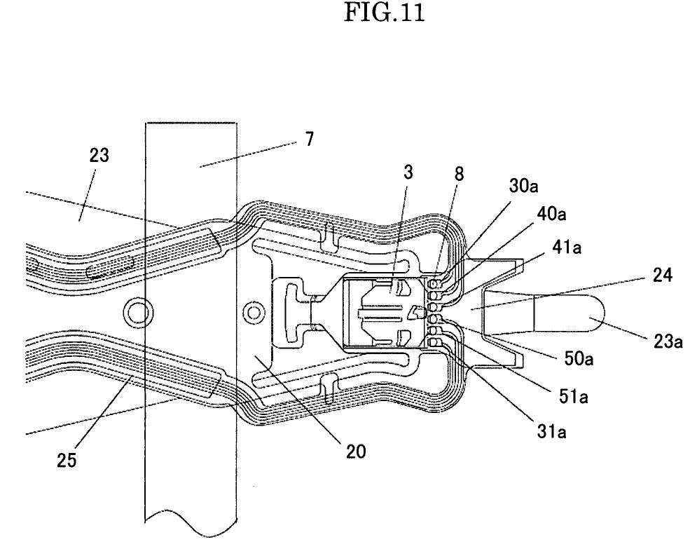

Here, a constraint imposed by the caulking of the suspension 2 with respect to the actuator block 1 at the manufacturing time of a magnetic disk unit will be described. FIG. 10 is a view showing an example of a structure when the suspension 2 is caulked to the actuator block 1 in the present embodiment. In FIG. 10, the same reference numerals as those in FIG. 1 denote the same or corresponding parts as those in FIG. 1, and the descriptions thereof will be omitted here. When the suspension 2 is caulked to the actuator block 1, jigs 7 are inserted between the respective suspensions 2 to fix the positions of the suspensions 2.

FIG. 11 is a view showing an example of a structure of a part in the vicinity of the magnetic head slider 3 when the suspension 2 according to the present embodiment is caulked to the actuator block 1. In FIG. 11, the same reference numerals as those in FIGS. 4 to 6 denote the same or corresponding parts as those in FIGS. 4 to 6, and the descriptions thereof will be omitted here. The respective signal line connection pads of the magnetic head slider 3 and respective signal lines of the suspension 2 are connected to each other by solder balls 8. The solder ball 8 may be a gold ball.

The magnetic disk drive according to the present embodiment adopts a load/unload mechanism and, therefore, has a load beam 23a for retaining the suspension 2 in a rail at the unload time.

When the load beam 23a is added, the inertia of the actuator is increased and levitation height of the magnetic head slider is reduced. In order to cope with the above, the size of the magnetic head slider 3 is reduced as compared to a conventional one (reduced from order of femtometer to order of picometer). Therefore, the width of each signal line connection pad of the magnetic head slider 3 and interval between the pads become reduced, making it difficult to draw the heater GND line 30a in the vicinity of the magnetic head slider 3 in the direction toward the load beam 23a for being connected to the flexure 20. Further, when the GND connection line 30b (nickel plating 26) is arranged in the portion where the jig 7 is inserted, the jig 7 may damage the GND connection line 30b (nickel plating 26), so that the nickel plating 26 is arranged away from the jig 7. Thus, the GND connection line 30b (nickel plating 26) is arranged in the location which is away from the jig 7 and other components and which is close to the magnetic head slider 3 as much as possible with a space that does not adversely affect the mechanical characteristics of the suspension. The location is closer to the magnetic head slider 3 than the center point of the suspension 2.

A head slider supporting device corresponds to the suspension 2 in the embodiment. A supporting portion corresponds to the flexure 20 in the embodiment. An insulation portion corresponds to the dielectric 24 in the embodiment. A connection portion corresponds to the GND connection line 30b.

The head slider supporting device according to the present embodiment can easily be applied to a storage device to thereby increase the performance thereof. An example of the storage device includes, e.g., a magnetic disk unit (storage device) and the like.

What is claimed is:

1. A head slider supporting device for supporting a head slider provided with at least a heater element, comprising:
a supporting portion that includes a conductor for supporting the head slider;
an insulation portion that includes a dielectric contacting the supporting portion;
a heater signal line that is a wiring for supplying a power to the heater element and that contacts the insulation portion;
a GND line for heater that is a wiring for connecting the heater element and a ground potential and that contacts the insulation portion; and
a GND connection portion that is a connection portion for connecting the GND line for heater and supporting portion.

2. The head slider supporting device according to claim 1, wherein
a GND connection terminal of the heater element is connected to a slider base plate of the head slider.

3. The head slider supporting device according to claim 1, wherein
both terminals of a magnetoresistive effect element provided on the head slider is connected to the slider base plate of the head slider via a high-resistance resistor provided on the head slider.

4. The head slider supporting device according to claim 1, wherein
the insulation portion has a hole for the GND connection portion to pass through.

5. The head slider supporting device according to claim 1, wherein
the GND connection portion is arranged in the position where it does not contact a jig and other components.

6. The head slider supporting device according to claim 1, further comprising:
one or more write signal lines that are wirings for supplying a power to a write element provided in the head slider;
one or more read signal lines that are wirings for supplying a power to a read element provided in the head slider;
a retaining portion that retains the heater signal line, write signal line, and read signal line, wherein
at least one of distances between the heater signal line and write signal line and between the heater signal line and read signal line is larger than a distance between the heater signal lines in a predetermined region in the retaining portion.

7. The head slider supporting device according to claim 6, wherein
the predetermined region is a Tail portion in a Long Tail suspension.

8. The head slider supporting device according to claim 6, wherein
the distance is a distance in the width direction of the head slider supporting device.

9. The head slider supporting device according to claim 8, wherein
the write signal line, heater signal line, and read signal line are arranged in this order in the width direction of the head slider supporting device.

10. A head slider supporting device for supporting a head slider provided with at least a heater element, comprising:
one or more heater signal lines that are wirings for supplying a power to the heater element;
one or more write signal lines that are wirings for supplying a power to a write element provided in the head slider;
one or more read signal lines that are wirings for supplying a power to a read element provided in the head slider;
a retaining portion that retains the heater signal line, write signal line, and read signal line, wherein
at least one of distances between the heater signal line and write signal line and between the heater signal line and read signal line is larger than a distance between the heater signal lines in a predetermined region in the retaining portion.

11. The head slider supporting device according to claim 10, wherein
the predetermined region is a Tail portion in a Long Tail suspension.

12. The head slider supporting device according to claim 10, wherein
the distance is a distance in the width direction of the head slider supporting device.

13. The head slider supporting device according to claim 12, wherein
the write signal line, heater signal line, and read signal line are arranged in this order in the width direction of the head slider supporting device.

14. A storage device comprising:
a head controller that controls a head section;
a supporting portion that includes a conductor for supporting a head slider in which the head section is provided;
an insulation portion that includes a dielectric contacting the supporting portion;
a heater signal line that is a wiring for connecting the head slider and head controller in order to control a heater provided in the head slider and that contacts the insulation portion;
a GND line for heater that is a wiring for connecting the heater and a ground and that contacts the insulation portion; and
a GND connection portion that is a connection portion for connecting the GND line for heater and supporting portion.

15. The storage device according to claim 14, wherein
the insulation portion has a hole for the GND connection portion to pass through.

16. The storage device according to claim 14, wherein
the GND connection portion is arranged in the position where it does not contact a jig and other components.

17. The storage device according to claim 14, further comprising:
one or more write signal lines that are wirings for supplying a power to a write element provided in the head slider;
one or more read signal lines that are wirings for supplying a power to a read element provided in the head slider;
a retaining portion that retains the heater signal line, write signal line, and read signal line, wherein
at least one of distances between the heater signal line and write signal line and between the heater signal line and read signal line is larger than a distance between the heater signal lines in a predetermined region in the retaining portion.

18. The storage device according to claim 17, wherein the predetermined region is a Tail portion in a Long Tail suspension.

19. The storage device according to claim 17, wherein
the distance is a distance in the width direction of the retaining portion.

20. The storage device according to claim 19, wherein
the write signal line, heater signal line, and read signal line are arranged in this order in the width direction.
